(19) United States
(12) Patent Application Publication
(10) Pub. No.: US 2026/0113246 A1
(43) Pub. Date: Apr. 23, 2026

(54) A DIGITAL TWIN-BASED SYSTEM AND A METHOD FOR THE 6G ECOSYSTEM

(71) Applicant: BTS KURUMSAL BILISIM TEKNOLOJILERI ANONIM SIRKETI, Atasehir/Istanbul (TR)

(72) Inventors: Kübra DURAN, Sariyer/Istanbul (TR); Mehmet ÖZDEM, Çankaya/Ankara (TR); Trung Quang DUONG, Belfast (GB); Berk CANBERK, Sariyer/Istanbul (TR); Gökhan YURDAKUL, Üsküdar/Istanbul (TR); Özgür PALANTÖKEN, Pendik/Istanbul (TR)

(21) Appl. No.: 19/116,338

(22) PCT Filed: Dec. 29, 2023
(86) PCT No.: PCT/TR2023/051857

§ 371 Date: Mar. 27, 2025

(30) Foreign Application Priority Data
Dec. 20, 2023 (TR) 2023/017783

(51) Int. Cl. H04L 41/14; H04L 41/0895; H04L 41/0896; H04L 41/122; H04L 43/20

(52) U.S. Cl. CPC H04L 41/145; H04L 41/0895; H04L 41/0896; H04L 41/122; H04L 43/20

(57) ABSTRACT

The invention relates to a data renewal system that provides a low latency at a high data communication rate and a high reliability, which are the basic requirements of the ultra-high data density (uHDD) and the event-defined ultra-reliable low latency communication (EDuRLLC) services in the sixth generation (6G) communication systems and that is a digital twin metric, and a method for operating the system.

### TECHNICAL FIELD

The invention relates to a data renewal system that provides a low latency at a high data communication rate and a high reliability, which are the basic requirements of the ultra-high data density (uHDD) and the event-defined ultra-reliable low latency communication (EDuRLLC) services in the sixth generation (6G) communication systems and that is a digital twin metric, and a method for operating the system.

### STATE OF THE ART

Today, digital twin modeling has started to be used to realize data-intensive applications such as the internet of things (IoT) in the 6G (sixth generation) infrastructure. Furthermore, 6G is expected to process very huge amounts of data, ultra-low latency, high transfer rates, and various types of data due to the diversity of IoT sensors.

In the state of the art, four types of twins are used in the digital twin modeling such as a descriptive twin, a predictive twin, a prescriptive twin and a cognitive twin. The complexity and maturity of the twin increases from the descriptive to the cognitive. In contrast to the low maturity levels, the cognitive twin needs the interactions of a virtual-to-virtual (V2V) and virtual-to-service (V2S) to communicate with various types of twin objects and twin systems.

Essentially, the cognitive ability is to manage the interactions between different types of digital twins. However, in a rule-based twinning, only the synchronization needs of the physical-to-virtual (P2V) and virtual-to-physical (V2P) interactions are considered. Additionally, in the state of the art, the additional data renewal methods are required to ensure a digital data quality in a timely manner by providing an actual and high-level interaction between different twins.

In another state of the art, there are some problems that digital twins need to overcome in order to understand and know that the updates are necessary. The most common examples are the synchronization problems and convergence problems between the physical and digital objects.

The traditional synchronization methods that are used to solve these problems are not sufficient to ensure the currency of the data in the V2V and V2S interactions. The problem of data currency for V2V and V2S interfaces is called consistency. If one twin updates itself with its own update frequency, the other twin which shares the same medium data is unable to know whether the shared data is updated or not. Consequently, a data consistency problem occurs for the data shared between the different object twins and the system twins.

There is a need to develop new systems and methods to overcome the state of the art and the aforementioned disadvantages.

### SUMMARY OF THE INVENTION

The invention relates to a data renewal system which is developed to eliminate the aforementioned disadvantages and to provide new advantages to the related technical field; and which meets the requirements of the ultra-high data density (uHDD) and event-defined ultra-reliable low latency communications (EDuRLLC) in the sixth generation (6G) communication systems and which is a digital twin metric and an operation method of a system.

The invention relates to a data renewal system that calculates the age of a twin which is a digital twin metric by using the device density, the packet expiry dates, the connection capacity and the buffer size metrics considering the virtual-to-virtual (V2V) and virtual-to-service (V2S) interfaces at the cognitive twin level. In this way, it is ensured that the data processed on the network is current at the required level.

The invention generates a digital twin model for 6G services in a parallel way to the real medium thanks to its low data update latency. Therefore, a virtual copy of the real physical medium is generated. As this virtual copy keeps the most current data in a time-independent manner, the tracking, managing and performance monitoring of the 6G services provided can be carried out in real time.

Since it is a common data update period for virtual-to-virtual (V2V) and virtual-to-service (V2S) interface, the invention eliminates the data consistency problem that may occur for the digital twins that share the same medium data by always keeping the current data in the system.

### DESCRIPTION OF THE FIGURES

The embodiments of the invention, which are briefly summarized above and discussed in more detail below, may be understood by referring to the exemplary embodiments of the invention which are illustrated in the appended drawings. However, it should be noted that the appended drawings only describe typical embodiments of the present invention and should not be considered to limit its scope.

FIG. 1 is a representative view of a diagram showing the working principle of the invention.

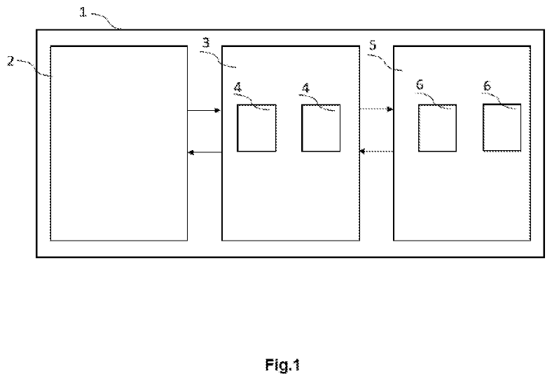

FIG. 2 is a representative view of a diagram showing the working principle of the invention.

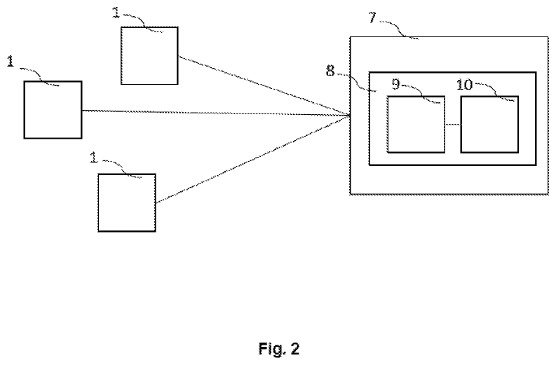

FIG. 3 is a representative view of a diagram showing the working principle of the method of the invention.

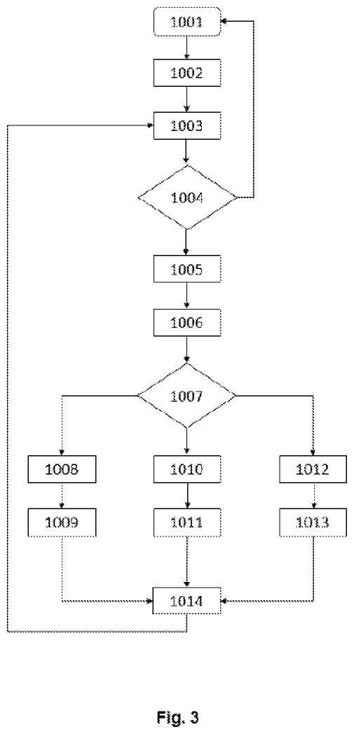

### DESCRIPTION OF THE REFERENCES IN THE FIGURES

For a better understanding of the invention, the description of the numbers in the figures is given below:
1. Digital Twin Software Module
2. Physical Layer Unit
3. Virtual Layer Unit
4. Virtual Model File
5. Service Layer Unit
6. Local Digital Twin Service Module
7. General Network Operation Service Module
8. Data Renewal Module
9. Service Identification Module
10. Calculation Module
1001. sending the data collected by at least one switch and at least one router or at least one IoT sensor located in the physical layer unit to the virtual layer unit
1002. generating the virtual models in the virtual layer unit of the switch and the router or the IoT sensor located in the physical layer unit with the virtual model file of said data,
1003. making the service definition with the local digital twin service module according to the requirement of the network located in the digital twin software module
1004. evaluating the number of the active digital twin models generated with the digital twin software module after the service definition and following the step 1001 if the number of the evaluated digital twin models is maximum 2
1005. providing an access setting to the general network operation service module for all digital twins that are generated, if the number of the evaluated digital twin models is at least 2
1006. transferring the data collected in the local digital twin service module to the data renewal module after the access has been provided
1007. carrying out an evaluation according to the network topology, service and traffic service types in the service definition module
1008. observing the topology changes as ultra-dynamically, dynamically and statically, if the type of the service is network topology-oriented according to the evaluation result
1009. keeping the weights of the metrics of the device density and the packet expiry dates high, together with the observed network topology chances
1010. observing the requirements of the services provided on IoT, the core network and the 6G network models, if the service type is service-oriented according to the evaluation results
1011. keeping the weights of the metrics of the packet expiry dates and the connection capacity high with the observed 6G service requirements
1012. examining the short and long term patterns of the traffic flowing on the network, if the service type is traffic-oriented according to the evaluation result
1013. keeping the weights of the metrics of the connection capacity and the buffer size high, with the examined traffic type patterns,
1014. calculating the data renewal period values in the calculation module using the data obtained as a result of the evaluation in the service definition module with the metrics that are adjusted according to the network topology, service and traffic service types.

### DETAILED DESCRIPTION OF THE INVENTION

The example arrangements are described in more detail below with reference to the accompanying descriptions. Moreover, the embodiments can be constituted in different forms and should not be interpreted as limited to the embodiments specified here. Instead, these exemplary embodiments are provided so that this description is in all respects comprehensive and its scope is fully transmitted to those skilled in the art.

The reliability of the communication services provided on a 5G infrastructure is 99.9%. The invention ensures that the reliability level is higher than a 5G technology, that is, it meets the need for a high reliability.

The invention is a system that provides a low latency of 100 microsecond levels at a high data communication rate and a high reliability, which are the basic requirements of the ultra-high data density (uHDD) and the event-defined ultra-reliable low latency communication (EDuRLLC) services in the sixth generation (6G) communication systems and that comprises at least one processor and at least one interface, wherein it comprises:
at least one digital twin software module (1) comprising at least one core network or at least one IoT sensor network of a network topology that operates on a processor and provides services in the 6G systems,
at least one physical layer unit (2) comprising at least one switch and at least one router or at least one IoT sensor,
at least one virtual layer unit (3) that keeps the virtual twins of the switches, router and sensors which are contained in the physical layer unit (2) in at least one database,
at least one virtual modal file (4) comprising operational and configurational data of the copies of the virtual twins located in the virtual layer unit (3) of the switches, routers and sensors which are contained in the core network or at least one IoT sensor network,
in the digital twin software module (1), at least one service layer unit (5) comprising the service software file in which the cognitive capabilities are performed and the service definitions are specified according to the network topology, service and traffic service types,
at least one local digital twin service module (6), which defines a service according to the requirement of the service provided by the switches, routers and sensors whose digital twin model is generated in the virtual layer unit (3),
at least one general network operation service module (7) comprising WIFI for the IoT application and the fiber optic communication modules for the core networks, which enable the different digital twin software modules (1) that share the same medium to communicate with each other,
at least one data renewal module (8) developed for the virtual-to-virtual (V2V) interfaces and the virtual-to-service (V2S) interfaces, where the collected data is stored on a storage unit which is at least one SSD and the data update period is determined,
in the implemented physical network, at least one service definition module (9) comprising the service software files implemented on an external processor that provides the definition of an ultra-dynamic, dynamic, and static pattern for the network topology-oriented service type; a IoT, core network, and 6G pattern for the service-oriented service type; and the short-term and long-term pattern for the network traffic-oriented service type,
at least one calculation module (10) comprising at least one calculation software file contained on an external processor that calculates the data renewal period using the device density, the packet expiry dates, the connection capacity and the buffer size metrics of the identifier of the age of the twin which is a digital twin metric.

For example, it is possible to define a load balancing service for the event-defined ultra-reliable low-latency service in the local digital twin service module (6) included in the invention. It is also provided the flexibility to implement different services in the 6G ecosystem and to define the required services.

By means of the general network operation service module (7) included in the invention, it is provided that the different digital twin software modules (1) that share the same medium communicate with high accuracy and reliability.

The most accurate data update period is provided for the virtual-to-virtual (V2V) and virtual-to-service (V2S) interfaces required for a real-time monitoring and management with the data renewal module (8).

It is ensured that three different service types included in the physical network are defined in a virtual copy with the service definition module (9).

The invention is a method for operating the system that provides a low latency at a high data communication rate and a high reliability, which are the basic requirements of the uHDD and EDuRLLC services in the 6G communication systems and that comprises at least one processor and at least one interface, wherein it comprises the process steps of:
sending the data collected by at least one switch and at least one router or at least one IoT sensor located in the physical layer unit (2) to the virtual layer unit (3) (1001),
generating the virtual models in the virtual layer unit (3) of the switch and the router or the IoT sensor located in the physical layer unit (2) with the virtual model file (4) of said data (1002),
making the service definition with the local digital twin service module (6) according to the requirement of the network located in the digital twin software module (1) (1003),
evaluating the number of the active digital twin models generated with the digital twin software module (1) after the service definition and following the step 1001 if the number of the evaluated digital twin models is maximum 2 (1004),
providing an access setting to the general network operation service module (7) for all digital twins generated, if the number of the evaluated digital twin models is at least 2 (1005),
transferring the data collected in the local digital twin service module (6) to the data renewal module (8) after the access has been provided (1006),
carrying out an evaluation according to the network topology, service and traffic service types in the service definition module (9) (1007),
observing the topology changes as ultra-dynamically, dynamically and statically, if the type of the service is network topology-oriented according to the evaluation result (1008),
keeping the weights of the metrics of the device density and the packet expiry dates high, together with the observed network topology chances (1009),
observing the requirements of the services provided on IoT, the core network and the 6G network models, if the service type is service-oriented according to the evaluation results (1010),
keeping the weights of the metrics of the packet expiry dates and the connection capacity high with the observed 6G service requirements (1011),
examining the short and long term patterns of the traffic flowing on the network, if the service type is traffic-oriented according to the evaluation result (1012),
keeping the weights of the metrics of the connection capacity and the buffer size high, with the examined traffic type patterns (1013),
calculating the data renewal period values in the calculation module (10) using the data obtained as a result of the evaluation (1007) in the service definition module (9) with the metrics that are adjusted according to the network topology, service and traffic service types (1014).

In one embodiment of the invention, the digital twin model created with the digital twin software module (1) which is included in the system and the operation method consists of 3 layers. There are the physical layer unit (2), the virtual layer unit (3) and the service layer unit (5), but the embodiment is not limited thereto.

In the step 1002 of the method according to the invention, each virtual model created has all the characteristics of the physical device that it represents.

If the type of the network specified in the step 1003 of the method according to the invention is an IoT network, it is possible to define a service that controls the mobility condition of the sensors in this topology, but the embodiment is not limited thereto.

If the number of the digital twin models evaluated in the step 1004 of the method according to the invention is less than 2, the method provides the data flow from the physical layer unit (2) to the virtual layer unit (3) again and provides an increase in the number of the digital twin models in the medium.

In the step 1005 of the method according to the invention, providing an access setting to the general network operation service module (7) for all digital twins establishes an infrastructure for a smooth communication of the digital twin models which use the same medium.

There are 3 separate processing queues in the data renewal module (8) which is included in the step 1006 of the method according to the invention. The data coming from local services to said module are divide into 3 separate queues according to the service types. Afterward, the service definition module (9) is followed. In the service definition module (9), the service requirement of the service within each queue are configured accordingly. For example, the parameters that are required to observe the ultra-dynamic, dynamic and stationary situations are set for the network topology service type queue.

In the step 1006 of the method according to an embodiment of the invention, the operations performed in the data renewal module (8) consist of 2 stages, namely grouping the services provided and calculating the age of the twin metric which is the digital twin metric, but the embodiment is not limited thereto.

In the step 1013 according to the invention, 4 metrics are used to calculate the age of the twin. Said metrics include the device density, the packet expiry dates, the connection capacity and the buffer size. These metrics are processed by prefixing a multiplier. Keeping the weight of a metric high means that one metric multiplier has a higher value than the other metric multipliers. For example, if the multipliers added at the beginning of the 4 metrics are a, b, c, d, the inputs to be provided to the algorithm that calculates the age of the twin will be as follows;
a. device density
b. packet expiry dates
c. connection capacity
d. buffer size

The sign “.” represents multiplication. The sum of these multipliers is numerically equal to 1 (a+b+c+d=1). In this case, if the service type is traffic type oriented, the metrics c and d will have numerically higher values than the metrics a and b. For the other types of the service types, these metrics are provided with different weights depending on the service required.

The invention calculates the age of a twin which is a digital twin metric by using the device density, the packet expiry dates, the connection capacity and the buffer size metrics considering the virtual-to-virtual (V2V) and virtual-to-service (V2S) interfaces at the cognitive twin level. Said calculation is carried out according to three application criteria that are primary in terms of the network topology, the service type and the traffic type and an approximate range of values is available for each type. The system according to the invention constitutes an exemplary umbrella term for the digital twin modeling in 6G infrastructure as it includes the different types of applications. Especially the implementation of a zero contact network management, together with the widespread use of the 6G services, ensures that the data processed on the network is kept current at the required level by considering the entire system in term of both operation, topology and performance in the replications performed by the network management experts.

The invention generates a digital twin model for 6G services in a parallel way to the real medium thanks to its low data update latency.

The digital twin model created is a virtual copy of the service that is provided in the real physical environment. This virtual copy has the capability to replicate the behavior of the real physical environment. In other words, the virtual copy created at the time t acts at the time t+1 in the same way as the real system (by keeping the most current data independent of time). For example, in a smart city (waste management) application included in a 6G ecosystem, the tracking of the IoT sensors that are placed on the garbage trucks and move due to the truck's travel can be tracked with the digital twin model in which information about the paths it will take is generated in the next time period. In this way, with the digital twin model generated, the tracking, management and performance evaluation of the services provided in the 6G ecosystem are provided in real time thanks to this virtual copy.

In one embodiment of the invention, the system and the method can also be used in 5G communication systems, on condition that the parameters contained and used by it are modified, but the embodiment is not limited thereto.

All the technical elements included in the system and method according to the invention carry out the operations mentioned in the invention via the processor and interface contained in the computer by means of a software.

Any property described in this specification (including the appended claims, abstract and figures) may be replaced by the other alternative properties which may have equivalent or similar purposes, unless clearly indicated otherwise. In other words, unless clearly indicated otherwise, each property is only one example of a set of equivalent or similar features.

It is intended that the terminology used in this description is used only to illustrate a specific exemplary embodiment and is not intended to be limiting. As used herein, the context of the forms “a”, “at least”, “preferably” and “and/or” comprises the plural forms unless indicated otherwise When the terms “comprises” and/other “including” are used in this specification, they do not prevent the presence or addition of the specified properties, integers, steps, processes, elements, and/or components, however one or more other properties, integers, steps, processes, elements, and/or components.

The foregoing embodiments are only intended to disclose the technical concept and properties of the present invention and the object of the invention is to enable those skilled in the art to understand and practice the content of the present invention, and the scope of the present invention is not limited thereto. The equivalent changes or modifications made in accordance with the idea of the invention are intended to be included in the scope of the invention.

### Industrial Applicability of the Invention

The invention relates to a data renewal system that provides a low latency and a high reliability at a high data communication rate, which are the basic requirements of the uHDD and EDuRLLC services in the 6G communication systems and that comprises at least one processor and at least one interface, and a method for operating the system, and it is applicable to the industry.

The invention is not limited to the above exemplary embodiments and the person skilled in the art can readily present other different embodiments of the invention. These should be considered within the protection scope of the invention claimed by the claims.

1. A data renewal system that provides a low latency of 100 microsecond levels at a high data communication rate and a high reliability, which are the basic requirements of the ultra-high data density (uHDD) and the event-defined ultra-reliable low latency communication (EDuRLLC) services in the sixth generation (6G) communication systems and that comprises at least one processor and at least one interface, characterized in that it comprises:
at least one digital twin software module (1) comprising at least one core network or at least one IoT sensor network of a network topology that operates on a processor and provides services in the 6G systems,
at least one physical layer unit (2) comprising at least one switch and at least one router or at least one IoT sensor,
at least one virtual layer unit (3) that keeps the virtual twins of the switches, router and sensors which are contained in the physical layer unit (2) in at least one database,
at least one virtual modal file (4) comprising operational and configurational data of the copies of the virtual twins located in the virtual layer unit (3) of the switches, routers and sensors which are contained in the core network or at least one IoT sensor network,
in the digital twin software module (1), at least one service layer unit (5) comprising the service software file in which the cognitive capabilities are performed and the service definitions are specified according to the network topology, service and traffic service types,
at least one local digital twin service module (6), which defines a service according to the requirement of the service provided by the switches, routers and sensors whose digital twin model is generated in the virtual layer unit (3),
at least one general network operation service module (7) comprising WIFI for the IoT application and the fiber optic communication modules for the core networks, which enable the different digital twin software modules (1) that share the same medium to communicate with each other,
at least one data renewal module (8) developed for the virtual-to-virtual (V2V) interfaces and the virtual-to-service (V2S) interfaces, where the collected data is stored on a storage unit which is at least one SSD and the data update period is determined,
in the implemented physical network, at least one service definition module (9) comprising the service software files implemented on an external processor that provides the definition of an ultra-dynamic, dynamic, and static pattern for the network topology-oriented service type; a IoT, core network, and 6G pattern for the service-oriented service type; and the short-term and long-term pattern for the network traffic-oriented service type,
at least one calculation module (10) comprising at least one calculation software file contained on an external processor that calculates the data renewal period using the device density, the packet expiry dates, the connection capacity and the buffer size metrics of the identifier of the age of the twin which is a digital twin metric.

2. A method for operating the system that provides a low latency of 100 microsecond levels at a high data communication rate and a high reliability, which are the basic requirements of the uHDD and EDuRLLC services in the 6G communication systems and that comprises at least one processor and at least one interface, characterized in that it comprises the steps of:
sending the data collected by at least one switch and at least one router or at least one IoT sensor located in the physical layer unit (2) to the virtual layer unit (3) (1001),
generating the virtual models in the virtual layer unit (3) of the switch and the router or the IoT sensor located in the physical layer unit (2) with the virtual model file (4) of said data (1002),
making the service definition with the local digital twin service module (6) according to the requirement of the network located in the digital twin software module (1) (1003),
evaluating the number of the active digital twin models generated with the digital twin software module (1) after the service definition and following the step 1001 if the number of the evaluated digital twin models is maximum 2 (1004),
providing an access setting to the general network operation service module (7) for all digital twins generated, if the number of the evaluated digital twin models is at least 2 (1005),
transferring the data collected in the local digital twin service module (6) to the data renewal module (8) after the access has been provided (1006),
carrying out an evaluation according to the network topology, service and traffic service types in the service definition module (9) (1007),
observing the topology changes as ultra-dynamically, dynamically and statically, if the type of the service is network topology-oriented according to the evaluation result (1008),
keeping the weights of the metrics of the device density and the packet expiry dates high, together with the observed network topology chances (1009),
observing the requirements of the services provided on IoT, the core network and the 6G network models, if the service type is service-oriented according to the evaluation results (1010),
keeping the weights of the metrics of the packet expiry dates and the connection capacity high with the observed 6G service requirements (1011),
examining the short and long term patterns of the traffic flowing on the network, if the service type is traffic-oriented according to the evaluation result (1012),
keeping the weights of the metrics of the connection capacity and the buffer size high, with the examined traffic type patterns (1013),
calculating (1014) the data renewal period values in the calculation module (10) using the data obtained as a result of the evaluation (1007) in the service definition module (9) with the metrics that are adjusted according to the network topology, service and traffic service types.

3. A method according to claim 2, characterized by providing a data flow from the physical layer unit (2) to the virtual layer unit (3) again to increase the number of the digital twin models in the medium, if the number of the digital twin models evaluated is less than 2 in the step 1004.

4. A method according to claim 3, characterized by grouping the services in the renewal module (8) and calculating the age of the twin metric which is a digital twin metric in the step 1006.

5. A method according to claim 4, characterized by processing 4 metrics which are the device density, the packet expiry dates, the connection capacity and the buffer size by prefixing a multiplier to calculate the age of twin in the step 1013.
